(19) United States
(12) Patent Application Publication
(10) Pub. No.: US 2002/0069260 A1
(43) Pub. Date: Jun. 6, 2002

(54) Systems and methods for printing website data

(76) Inventor: James S. Tagg, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/728,302

(22) Filed: Dec. 1, 2000

(51) Int. Cl. G06F 17/60; G06F 15/16

(52) U.S. Cl. 709/218; 705/26

(57) ABSTRACT

Systems and methods for direct printing of website data. The method includes providing a website with a web page that may be accessed by a browser program, and providing printable content that is associated with the website but not displayed on the web page. A print activator is displayed on the web page, and the content is printed in response to user activation of the print activator. The print activator may be configured to initiate printing independent of any operation of print controls provided on the browser program. Alternatively, the activator may be configured to enable a user to initiate processing of print jobs without having to operate the print controls provided on the browser program.

### FIELD OF THE INVENTION

The present invention relates to systems and methods for printing website data.

### BACKGROUND OF THE INVENTION

Information and the systems for storing and retrieving it are increasingly being implemented on networked computer systems. Though computer displays are improving in quality and computing devices are becoming more portable, computer users continue to want data printed out in hard copy form. Some users want printouts for filing or archival purposes. Others want to make handwritten notes on printouts. Some simply prefer to read printed matter instead of content displayed on a computer screen.

Many computer-based systems exist for accessing, displaying and printing materials. Typically, content is printed in response to user activation of print controls provided on a software program configured to access and display the content. For example, web browsers are widely used to retrieve and display information stored on computer networks such as the Internet. The web browser includes print controls that are activated in order to initiate printing of content displayed by the browser.

At times, it is necessary and/or more convenient to display and print material using a supplemental viewing program instead of a web browser. Adobe® Acrobat® Reader is an example of a widely used supplemental viewing program. Supplemental viewing programs are often launched automatically by web browsers when the browser is used to access certain types of material.

Whether accessed directly with a browser or with a supplemental viewing program, printable content is invariably printed using print controls provided on the browser/viewer program, and is displayed by the program in connection with the printing operation. In some cases, certain steps performed in the conventional methods to print content are unnecessary and potentially wasteful. For example, depending on the application, some users may only want to print out a document, and may have no need to view or otherwise access the document. In such a case, displaying the material and/or launching a supplemental viewer program needlessly consumes resources and adds steps and time to the printing process.

### SUMMARY OF THE INVENTION

Accordingly, the present invention provides systems and methods for direct printing of website data. The method includes providing a website with a web page that may be accessed by a browser program, and providing printable content that is associated with the website but not displayed on the web page. The method further includes displaying a print activator on the web page, and printing the content in response to user activation of the print activator. The print activator may be configured to initiate printing independent of any operation of print controls provided on the browser program. Alternatively, the activator may be configured to enable a user to initiate processing of print jobs without having to operate the print controls provided on the browser program.

### BRIEF DESCRIPTION OF THE FIGURES

FIG. 1 is a networked computer system in which printing systems and methods according to the present invention may be implemented.

FIG. 2 is a schematic diagram of one of the computing devices depicted in FIG. 1.

FIG. 3 is a browser program configured to run on the computing devices depicted in FIGS. 1 and 2 in order to access, display and print content stored on a network. The figure also depicts a website according to the present invention, including a web page having a print activator displayed on the web page for initiating printing of content associated with the website.

FIG. 4 depicts a printing method according to the present invention.

FIG. 5 depicts a method according to the present invention of delivering a catalog in printed form to a customer.

### DETAILED DESCRIPTION OF THE INVENTION

The present invention is directed to computer-based systems and methods for printing material in hard copy form. The principles of the invention are applicable to a wide variety of computer-based applications, in both networked and standalone computing environments. The invention is particularly useful, however, in networked settings such as the Internet, where connected computing devices access, display and print viewable material using browser software.

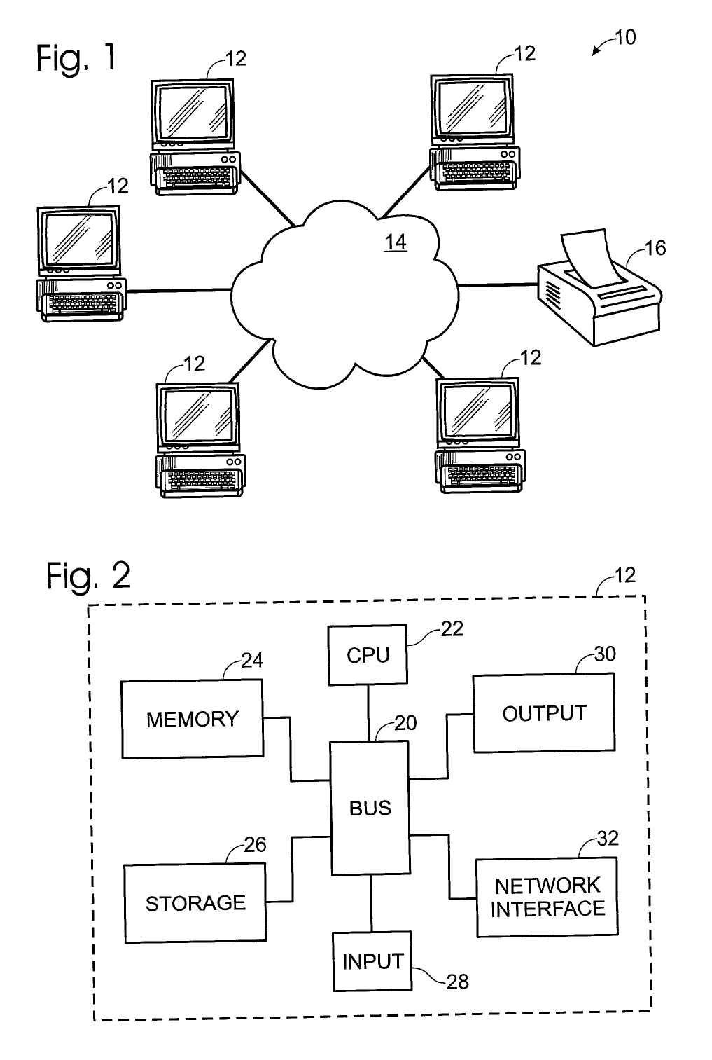

FIG. 1 depicts a networked computer system 10 in which printing systems and methods according to the present invention may be implemented. Networked computer system 10 includes various computing devices 12 interconnected by telecommunications network 14. As seen in FIG. 2, computing device 12 typically includes a bus 20 interconnecting a central processing unit 22 (CPU), memory 24, storage device 26 (e.g. a hard disk), and input 28 and output 30. Input 28 may include various devices, such as a keyboard, mouse, joystick etc. Output 30 may include a display monitor, printing device and various other devices. Computing device 12 may also include a network interface 32 to enable communication with telecommunication network 14.

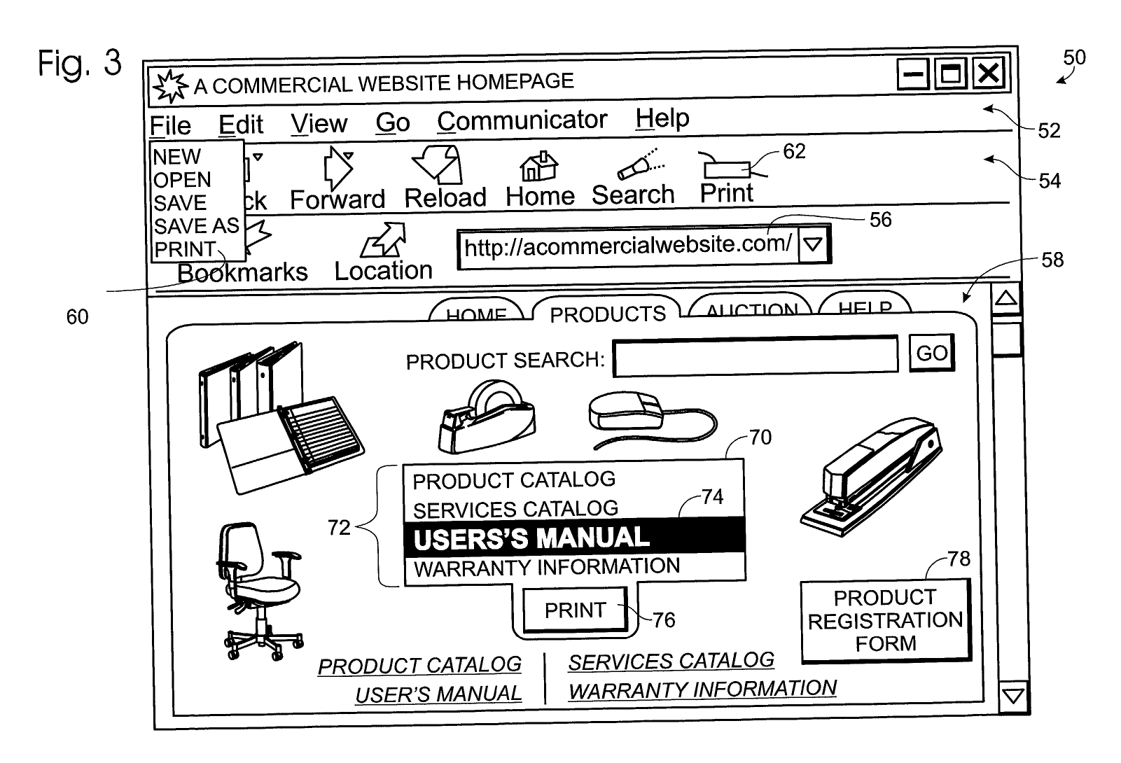

FIG. 3 depicts a browser 50 that may be used to access, display and print content stored on a network, such as that depicted in FIG. 1. Browser 50 includes a number of pull down menus (File, Edit, View, etc.) that provide various userselectable functions. The browser also has a toolbar 54 including various buttons for activating frequently accessed features and functions. Browser also includes an address window 56 that provides indication of the location of the content displayed in browser window 58.

The accessed content may be stored on one or more of the computers that are coupled to the network. Typically, the content is stored in a location remote from the accessing computer (the computer running the browser program). At times, however, it may be desirable to access locally stored content using a browser program. For example, a browser program running locally from memory 24 of computing device 12 may be used to access and display web pages stored on hard disk 26.

Typically, matter to be printed at printing device 16 is displayed prior to being printed. For example, the content to be printed is often displayed in main browser window 58 prior to printing. Often it is necessary or desirable to reformat certain types of material before the material is printed. For example, it is common practice on the Internet for information providers to provide a feature allowing displayed content to be re-displayed in a “printer-friendly” format. This can involve changing margins, removing specialized formatting, removing advertisements, etc.

Sometimes content is provided in a format that is not directly supported by the browser. In such a case, a supplemental viewer program may be used to display and print the content. For example, many browser programs do not directly support viewing of documents stored in portable document format (PDF). When the primary browser is used to access PDF documents, a second viewing program may be automatically launched to display the document. Printing functions are typically provided with supplemental viewing programs, enabling a user to print out a hard copy of the displayed content. In any event, similar to when material is printed directly with the main browser program, the content is displayed by the viewer prior to the user initiating printing of the content.

Once the content to be printed is displayed, printing is typically initiated by user actuation of print controls provided on the main browser program or on the supplemental viewer program. Actuation of these controls initiates processing of the print job by print drivers loaded locally on the computing device. For example, material displayed in browser window 58 may be printed by user activation of print command 60 provided on the “File” pull-down menu, or by activation of print button 62 provided on toolbar 54.

In many cases, it is not necessary that matter to be printed be displayed in connection with the printing operation. For a variety of reasons, the user may want a hard copy of the printable content but not have any need to view the material to be printed onscreen. Many people, for example, prefer to read lengthy or detailed documents in hard copy form instead of reading them on a computer screen. Others like to read materials in places other than where their computer is located. Still others like to make handwritten notes on printed material or perform edits on a printout of the content.

Accordingly, one aspect of the present invention provides a system that enables direct printing of content without having the content substantively displayed by a browser or supplemental viewing program. FIG. 3 depicts an implementation of the invented system and method in connection with a website used to sell office products. A web page associated with the website is displayed in main browser window 58.

The web page includes a selection window 70 in which several items 72 of printable content are listed. An item is selected for printing (e.g. selected item 74) and is directly printed by activating a print activator, such as print button 76, that is displayed on the web page. As indicated at 78, the print activator may also be provided in link form on the web page, such that activation of the link initiates printing of the referenced document. In the illustrated example, clicking on link 78 causes a product registration form to be printed. Regardless of the form of the print further includes, at 104, displaying a print activator on the web page. Finally, at 106, the method includes printing the content in response to user activation of the print activator. As previously described, the print activator is configured to initiate printing independent of any operation of print controls provided on the browser program. This enables a user to cause a print job to be processed without having to operate the print controls provided on the browser program.

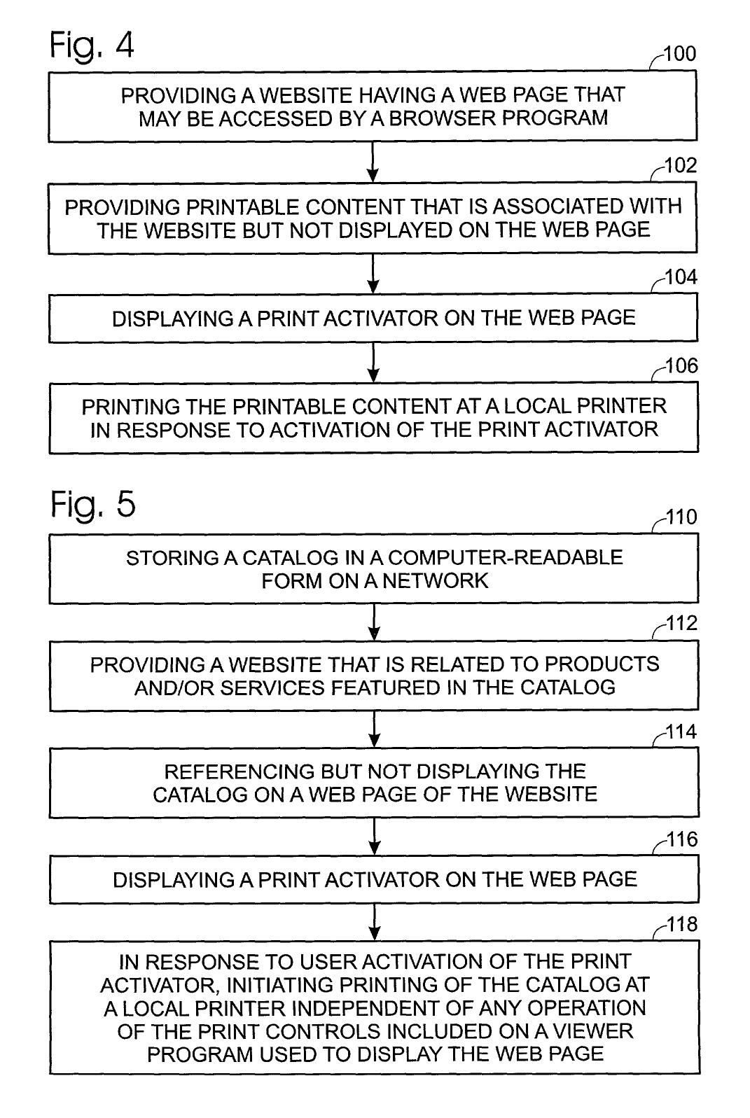

In addition, various implementations of the present invention may be considered as methods of delivering documents to customers. FIG. 5 provides an illustration of a catalog delivery method. At 110, the depicted method involves storing a catalog in computer-readable form on a network. The method further includes providing a website that is related to the products or services featured in the catalog, as indicated at 112. The method further includes, at 114, referencing the catalog on a web page of the website. As indicated, the catalog itself typically is not displayed on the web page. Similar to the previously described implementations, the depicted method includes providing a print activator on the web page and initiating processing of print jobs in response to user activation of the print activator, as respectively indicated at 116 and 118. As described in connection with the method depicted in FIG. 4, the print activator is independent of the print controls provided on software used to access and display content.

Direct printing of website data as described above has a number of advantages. In many implementations, the invention reduces by at least half the number of steps required to obtain printed hard copy output. The systems and methods of the present activator, its activation initiates processing of the print job independent of any operation of the browser print controls (i.e. print button 62 or print command 60). The user does not have to activate the browser print controls at all to initiate processing of the print job. The print activator thus provides an alternate means by which users of a browser program can print material.

Typically, the functionality provided by the browser print controls (or by the print controls of a supplemental viewer) is bypassed entirely by user activation of the print activator. In many implementations of the present invention, activating the print activator causes the printing task to be passed directly to locally resident print drivers. Alternatively, the print job may be downloaded directly to a printer or transferred to a print queue. In any case, the printing system may be configured so that larger print jobs are divided into a number of smaller segments, so as not to overload buffers, queues, or other printer resources.

It should be understood that the invention encompasses not only a system, but also various methods for printing website data. FIG. 4 provides an illustration of such a method. The depicted method includes, at 100, providing a website having a web page that may be accessed by a browser program, such as browser 50. As seen at 102, the method also involves providing printable content associated with the website but not displayed on the web page. “Not displayed” means that the content is not presented for online viewing in a format similar to how it appears when printed. However, as indicated in FIG. 3, the printable content may be displayed in icon form, as a link, or with some other type of reference identifying the content. The method invention described above are typically implemented as “one-click” functions. In contrast, the prior methods involve several steps, including, at a minimum, displaying the document in a format supported by the browser/viewer program, and activating print controls provided on the browser/viewer program. Additionally, it is often necessary to launch a supplemental viewer program to view and/or print a document. Also, the present systems and methods avoid the resource consumption associated with launching and running a supplemental viewing program.

The implementations of the present invention described above afford a number of other advantages, including benefits to information providers and vendors of products and services. For example, in the context of catalog delivery, the present invention eliminates costs associated with printing and mailing catalogs to customers. Printed matter is delivered in a more targeted manner—i.e., more targeted than mass catalog mailings—to consumers who specifically request the information by printing it off of the website. Because it is more focused, this method also saves on paper and the other resources consumed in printing and delivering catalogs to customers.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

I claim:

1. A printing method, comprising:
providing a website having a web page accessible via a browser program, the browser program having browser print controls for initiating processing of print jobs;
providing printable content that is associated with the website but not displayed on the web page;
providing a print activator on the web page, where activation of the print activator enables a user to initiate printing without having to operate the browser print controls; and
in response to user activation of the print activator, printing the printable content at a printer.

2. The method of claim 1, where the printable content is a catalog featuring consumer products and/or services.

3. The method of claim 1, where the print activator takes the form of a hyperlink that identifies the printable content.

4. The method of claim 1, where the print button activates the print processing functions provided on the computer running the browser program.

5. The method of claim 1, where activation of the print button causes printing to be performed by bypassing the print features provided on the browser program.

6. The method of claim 1, where the print button causes the printable content to downloaded directly to the printer.

7. The method of claim 1, where the printable content is separated into a plurality of sections that are downloaded individually to the printer.

8. The method of claim 1, where the printable content is not formatted for display by the web browser, but rather is specially formatted for output in printed hard copy form.

9. A printing method, comprising:
providing a website having a web page accessible via a browser program, the browser program having browser print controls for initiating processing of print jobs;
providing printable content that is associated with the website but not displayed on the we b page;
displaying a user-actuable print activator on the web page; and
in response to activation of the print activator, initiating printing of the printable content at a printer independent of any operation of the browser print controls.

10. The method of claim 9, where the printable content is a catalog featuring consumer products and/or services.

11. The method of claim 9, where the print activator takes the form of a hyperlink that identifies the printable content.

12. The method of claim 9, where the print button activates the print processing functions provided on the computer running the browser program.

13. The method of claim 9, where activation of the print button causes printing to be performed by bypassing the print features provided on the browser program.

14. The method of claim 9, where the print button causes the printable content to downloaded directly to the printer.

15. The method of claim 9, where the printable content is separated into a plurality of sections that are downloaded individually to the printer.

16. The method of claim 9, where the printable content is not formatted for display by the web browser, but rather is specially formatted for output in printed hard copy form.

17. A system for printing printable content associated with a website, comprising:
a website having a web page, where the printable content is not displayed on the web page;
a computer running a browser program capable of displaying the web page, where the browser program includes browser print controls for initiating processing of print jobs; and
a user-actuable print activator displayed on the web page, where when the web page is displayed by the browser, activation of the print activator initiates printing of the printable content at a printer independent of any operation of the browser print controls.

18. A method of providing a catalog in printed form to a customer, comprising:
storing the catalog in computer-readable form in a memory location accessible from a communications network;
providing a website that is related to products and/or services featured in the catalog;
referencing but not displaying the catalog on a web page included on the website, where a user-actuable print activator is displayed on the web page; and
in response to customer activation of the print activator, initiating printing of the catalog at a local printer, where the printing is initiated without the customer having to operate print controls included on a browser program used to display the web page.
